(19) United States
(12) Patent Application Publication
(10) Pub. No.: US 2023/0174130 A1
(43) Pub. Date: Jun. 8, 2023

(54) HANDCART

(71) Applicant: MAKITA CORPORATION, Anjo-shi (JP)

(72) Inventor: Yoshinori SHIBATA, Anjo-shi (JP)

(73) Assignee: MAKITA CORPORATION, Anjo-shi (JP)

(21) Appl. No.: 17/993,521

(22) Filed: Nov. 23, 2022

(30) Foreign Application Priority Data
Dec. 8, 2021 (JP) 2021-199371

(51) Int. Cl. B62B 5/00; B62B 3/00; B62B 5/06

(52) U.S. Cl. CPC B62B 5/0033; B62B 3/00; B62B 5/06; B62B 5/0069; B62B 3/002

(57) ABSTRACT

A handcart may include a prime mover, a first ground-contact part, a second ground-contact part, a clutch mechanism configured to switch between a transmission state and a non-transmission state, a differential mechanism configured to switch between a non-locking state and a locking state, a switching unit configured to switch a state of the clutch mechanism and a state of the differential mechanism; and an operation unit. The switching unit may be configured to: in response to a user’s first operation, switch the state of the clutch mechanism between the transmission state and the non-transmission state without switching the state of the differential mechanism, and in response to a user’s second operation, switch the state of the differential mechanism between the non-locking state and the locking state without switching the state of the clutch mechanism.

### CROSS-REFERENCE TO RELATED APPLICATION

This application claims priority to Japanese Patent Application No. 2021-199371 filed on Dec. 8, 2021, the contents of which are hereby incorporated by reference into the present application.

### TECHNICAL FIELD

The art disclosed herein relates to a handcart.

### BACKGROUND ART

Japanese Utility Model Application Publication No. S62-31575 (JP S62-31575 U) describes a wheel steering device including a prime mover, a first ground-contact part and a second ground-contact part, a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part, a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state being a state prohibiting the rotation difference from occurring between the first ground-contact part and the second ground-contact part, a switching unit, and an operation unit. The switching unit is configured to switch both the state of the differential mechanism and the state of the clutch mechanism simultaneously in response to a user’s operation on the operation unit.

### SUMMARY

The above wheel steering device is configured capable of realizing only two states, in one of which the clutch mechanism is in the transmission state and the differential mechanism is in the non-locking state and in the other of which the clutch mechanism is in the non-transmission state and the differential mechanism is in the locking state. For example, in the wheel steering device of JP S62-31575 U, a state in which the clutch mechanism is in the transmission state and the differential mechanism is in the locking state cannot be realized. In this case, for example, in a situation where only one of the first ground-contact part and the second ground-contact part is contacting the ground, it becomes difficult to transmit torque from the prime mover to the ground-contact part that is in contact with the ground, and a user may feel the inconvenience arising from this situation.

The description herein provides an art configured to improve user convenience.

A handcart disclosed in the present disclosure may comprise: a prime mover; a first ground-contact part and a second ground-contact part that are configured to be driven by the prime mover; a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part; a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part, and the locking state is a state prohibiting the rotation difference from occurring between the first ground-contact part and the second ground-contact part; a switching unit configured to switch a state of the clutch mechanism and a state of the differential mechanism; and an operation unit. The switching unit may be configured to: in response to a user’s first operation on the operation unit, switch the state of the clutch mechanism between the transmission state and the non-transmission state without switching the state of the differential mechanism, and in response to a user’s second operation on the operation unit, switch the state of the differential mechanism between the non-locking state and the locking state without switching the state of the clutch mechanism.

According to the above configuration, by performing the first operation on the operation unit, the user can switch the state of the clutch mechanism between the transmission state and the non-transmission state without switching the state of the differential mechanism. Further, by performing the second operation on the operation unit, the user can switch the state of the differential mechanism between the non-locking state and the locking state without switching the state of the clutch mechanism. According to such a configuration, three states can be realized by the switching unit, namely a state in which the differential mechanism is in the non-locking state and the clutch mechanism is in the transmission state, a state in which the differential mechanism is in the non-locking state and the clutch mechanism is in the non-transmission state, and a state in which the differential mechanism is in the locking state and the clutch mechanism is in the transmission state. Thus, user convenience can be improved.

Another handcart disclosed in the present disclosure may comprise: a prime mover; a first ground-contact part and a second ground-contact part that are configured to be driven by the prime mover; a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part; a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state is a state prohibiting the rotation difference from occurring between the first ground-contact part and the second ground-contact part; a switching unit configured to switch a state of the clutch mechanism and a state of the differential mechanism; and an operation unit. The switching unit may be configured to move between a first position, a second position and a third position in response to a user’s operation on the operation unit. When the switching unit is at the first position, the differential mechanism is in the non-locking state and the clutch mechanism is in the transmission state. When the switching unit is at the second position, the differential mechanism is in the non-locking state and the clutch mechanism is in the non-transmission state. When the switching unit is at the third position, the differential mechanism is in the locking state and the clutch mechanism is in the transmission state.

According to the above configuration, the switching unit can be moved to one of the first to third positions in accordance with the user’s operation on the operation unit. Further, the three states can be realized by the switching unit, namely the state in which the differential mechanism is in the non-locking state and the clutch mechanism is in the transmission state, the state in which the differential mechanism is in the non-locking state and the clutch mechanism is in the non-transmission state, and the state in which the differential mechanism is in the locking state and the clutch mechanism is in the transmission state. Thus, the user convenience can be improved.

### BRIEF DESCRIPTION OF THE DRAWINGS

FIG. 1 is a perspective view seeing a handcart 2 of an embodiment from front right upper side.

FIG. 2 shows a control configuration of the handcart 2 of the embodiment.

FIG. 3 is a perspective view seeing an operation unit 38 from rear left upper side in a state where an operation lever 52 is located in a first operating position.

FIG. 4 is a perspective view seeing the operation unit 38 from front left upper side in a state where the operation lever 52 is located in a second operating position.

FIG. 5 is a perspective view seeing the operation unit 38 from the rear left upper side in a state where the operation lever 52 is located in a third operating position.

FIG. 6 is a top view seeing a front wheel unit 16 of the embodiment from above.

FIG. 7 is a horizontal cross-sectional view of a motor 106 and a gearbox 108 of the embodiment with a clutch mechanism 144 in a transmission state and a differential mechanism 146 in a non-locking state.

FIG. 8 is a perspective view seeing the front wheel unit 16 of the embodiment from rear right upper side in a state where a cover 111 is detached and a switching unit 110 is located in a first switching position.

FIG. 9 is a perspective view seeing the switching unit 110 of the embodiment from the rear right upper side.

FIG. 10 is a perspective view seeing a second base plate 180 of the embodiment from the rear right upper side.

FIG. 11 is a cross-sectional view seeing the switching unit 110 of the embodiment from the right.

FIG. 12 is a perspective view seeing a clutch switching unit 182 of the embodiment from the rear right upper side.

FIG. 13 is a bottom view seeing a first rotating unit 202 of the clutch switching unit 182 of the embodiment from below.

FIG. 14 is a perspective view seeing a differential lock switching unit 184 of the embodiment from the rear right upper side.

FIG. 15 is a bottom view seeing a second rotating unit 232 of the differential lock switching unit 184 of the embodiment from below.

FIG. 16 is a perspective view seeing the switching unit 110 of the embodiment from the rear right upper side with the switching unit 110 located in a second switching position.

FIG. 17 is a horizontal cross-sectional view of the motor 106 and the gearbox 108 of the embodiment with the clutch mechanism 144 in a non-transmission state and the differential mechanism 146 in the non-locking state.

FIG. 18 is a perspective view seeing the switching unit 110 from the rear right upper side with the switching unit 110 located in a third switching position.

FIG. 19 is a horizontal cross-sectional view of the motor 106 and the gearbox 108 of the embodiment with the clutch mechanism 144 in the transmission state and the differential mechanism 146 in a locking state.

FIG. 20 is a schematic view of a switching unit 410 of a fourth variant.

### DETAILED DESCRIPTION

Representative, non-limiting examples of the disclosure herein will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved handcarts, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a handcart may comprise: a prime mover; a first ground-contact part and a second ground-contact part that are configured to be driven by the prime mover; a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part; a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part, and the locking state being a state prohibiting the rotation difference from occurring between the first ground-contact part and the second ground-contact part; a switching unit configured to switch a state of the clutch mechanism and a state of the differential mechanism; and an operation unit. The switching unit may be configured to: in response to a user’s first operation on the operation unit, switch the state of the clutch mechanism between the transmission state and the non-transmission state without switching the state of the differential mechanism, and in response to a user’s second operation on the operation unit, switch the state of the differential mechanism between the non-locking state and the locking state without switching the state of the clutch mechanism.

In one or more embodiments, a handcart may comprise: a prime mover; a first ground-contact part and a second ground-contact part that are configured to be driven by the prime mover; a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part; a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state is a state prohibiting the rotation difference from occurring between the first ground-contact part and the second ground-contact part; a switching unit configured to switch a state of the clutch mechanism and a state of the differential mechanism; and an operation unit. The switching unit may be configured to move between a first position, a second position and a third position in response to a user’s operation on the operation unit. When the switching unit is at the first position, the differential mechanism is in the non-locking state and the clutch mechanism is in the transmission state. When the switching unit is at the second position, the differential mechanism is in the non-locking state and the clutch mechanism is in the non-transmission state. When the switching unit is at the third position, the differential mechanism is in the locking state and the clutch mechanism is in the transmission state.

In one or more embodiments, the state of the clutch mechanism and/or the state of the differential mechanism may be switched by movement of the switching unit along a first direction.

According to the above configuration, the configuration of the switching unit can be simplified as compared to the configuration in which the state of the clutch mechanism and/or the state of the differential mechanism are switched by the switching unit moving in multiple directions.

In one or more embodiments, the handcart may further comprise a handle configured to be gripped by a user. The operation unit may be disposed on the handle.

According to the above configuration, the user can easily operate the operation unit. Thus, user convenience can further be improved.

In one or more embodiments, the switching unit may comprise a position indicator configured to indicate a position of the switching unit relative to the clutch mechanism and the differential mechanism.

According to the above configuration, the user can acknowledge the state of the differential mechanism and the state of the clutch mechanism by checking the position of the switching unit indicated by the position indicator. Thus, the user convenience can further be improved.

### Embodiment

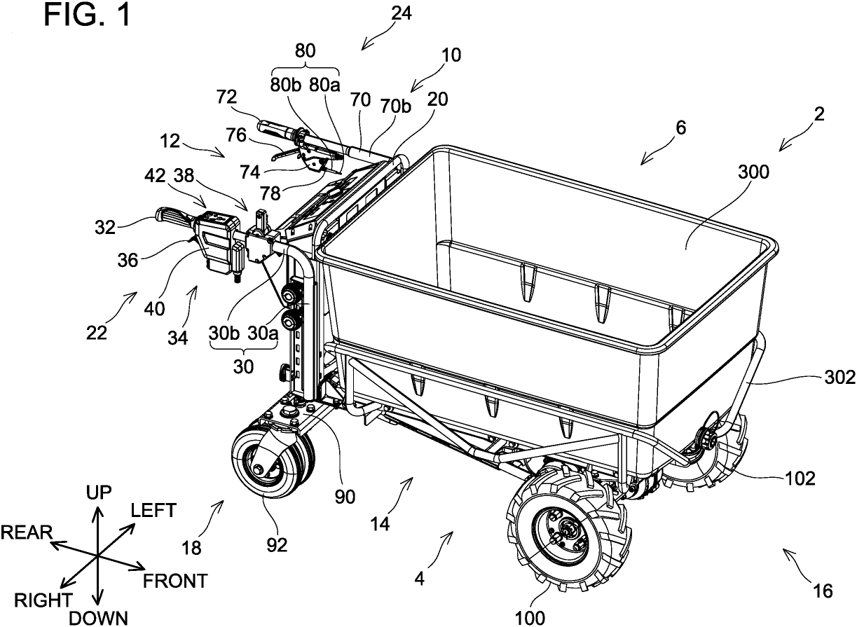

As shown in FIG. 1, a handcart 2 comprises a chassis unit 4 and a carrier unit 6. The carrier unit 6 includes a bucket 300 and a carrier frame 302 extending in a front-rear direction. The carrier frame 302 is fixed to the chassis unit 4 in the carrier unit 6 by screws. Further, in the carrier unit 6, the bucket 300 is not fixed to the carrier frame 302, thus a user can place the bucket 300 on the carrier frame 302 and also can lift the bucket 300 and remove it from the carrier frame 302. The user can carry soil, fertilizer, and the like in the bucket 300.

### Configuration of Chassis Unit 4

The chassis unit 4 includes a handle unit 10, a battery box 12, a chassis frame 14, a front wheel unit 16, and a rear wheel unit 18.

### Configuration of Battery Box 12

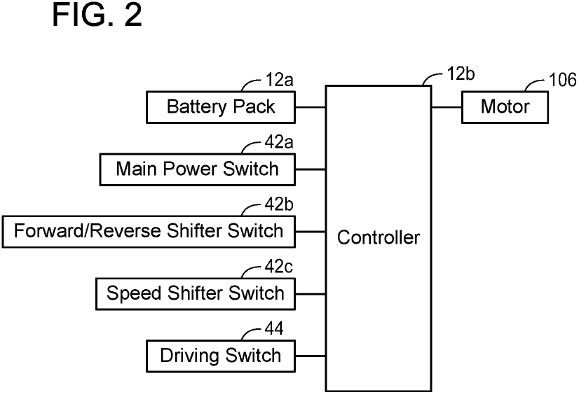

The battery box 12 is fixed to the handle unit 10. The battery box 12 houses a battery pack 12a (see FIG. 2) and a controller 12b (see FIG. 2). The controller 12b (see FIG. 2) is configured to control operations of a motor 106 (see FIG. 2) to be described later. The battery box 12 includes a remaining charge indicator (omitted from drawings) configured to display remaining charge in the battery pack 12a (see FIG. 2).

### Configuration of Handle Unit 10

The handle unit 10 includes a handle base 20, a right handle 22, and a left handle 24. The right handle 22 and the left handle 24 are screwed onto the handle base 20. The handle base 20 is screwed onto the chassis frame 14. The battery box 12 is screwed onto the handle base 20.

The right handle 22 includes a right pipe 30, a right grip 32, a switch box 34, an actuation lever 36, and an operation unit 38. The right pipe 30 includes a right supporting part 30a extending in an up-down direction and a right handle part 30b that bends rearward from an upper end of the right supporting part 30a. The right grip 32, the switch box 34, and the operation unit 38 are fixed to the right handle part 30b of the right pipe 30. The right grip 32 is arrange behind the switch box 34. The switch box 34 is arranged behind the operation unit 38.

The switch box 34 includes a switch casing 40 and an operation panel 42. The operation panel 42 is arranged on an upper surface of the switch casing 40. The operation panel 42 includes a plurality of switches (such as a main power switch 42a (see FIG. 2), a forward/reverse shifter switch 42b (see FIG. 2), and a speed shifter switch 42c (see FIG. 2)). The actuation lever 36 is arranged in a rear portion of the switch casing 40. A driving switch 44 (see FIG. 2) configured to detect that a pull-up operation was performed on the actuation lever 36 is arranged in the switch box 34. When the controller 12b receives a signal indicating that the pull-up operation was performed on the actuation lever 36 from the driving switch 44 (see FIG. 2), the controller 12b actuates the motor 106 (see FIG. 2) to be described later.

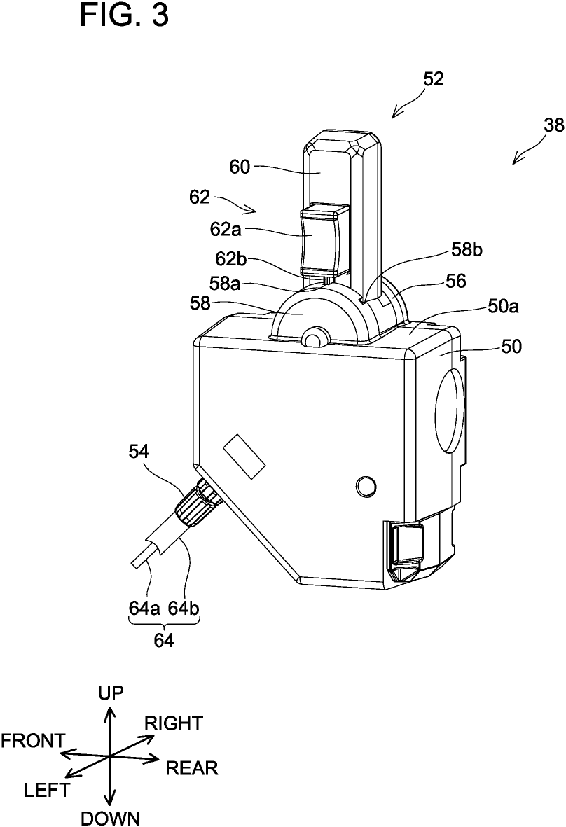

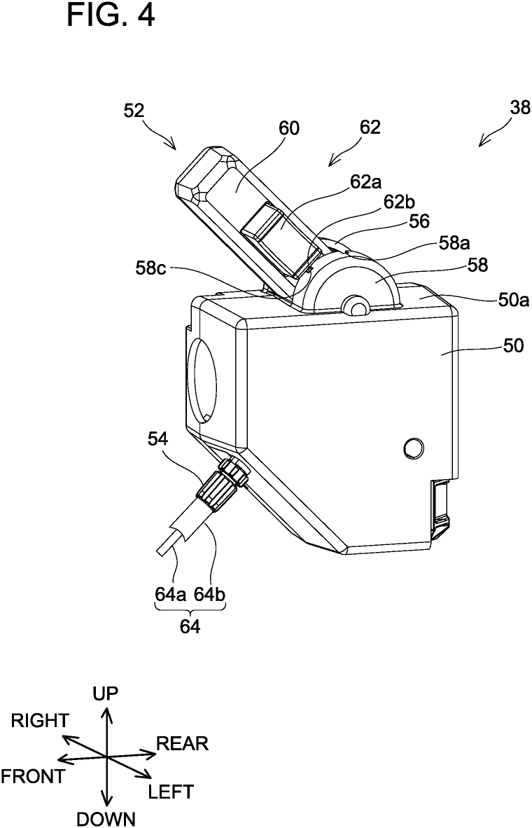

As shown in FIG. 3, the operation unit 38 includes an operation casing 50, an operation lever 52, and a first operation cable retainer 54. A right retainer 56 and a left retainer 58 configured to retain the operation lever 52 are arranged on an upper surface 50a of the operation casing 50. The right retainer 56 and the left retainer 58 each have a semicircular shape with its upper portion protruding out as seen from the left. The left retainer 58 includes a central cutout portion 58a extending leftward from a right end of the left retainer 58, a rear cutout portion 58b arranged on the rear side of the central cutout portion 58a, and a front cutout portion 58c arranged on the front side of the central cutout portion 58a (see FIG. 4).

The operation lever 52 is supported so as to be rotatable about a rotation axis (omitted from drawings) extending in the left-right direction with respect to the operation casing 50 (more specifically, the right retainer 56 and the left retainer 58). The operation lever 52 includes a grip 60 and a lock unit 62. The lock unit 62 includes a lock button 62a to be pressed in by the user, and an engaging part 62b extending downward from the lock button 62a and having a shape configured to engage with one of the central cutout portion 58a, the rear cutout portion 58b, and the front cutout portion 58c (see FIG. 4) of the left retainer 58. The lock button 62a and the engaging part 62b are integrated. The lock button 62a and the engaging part 62b are biased leftward with respect to the operation casing 50 by a compression spring (omitted from drawings).

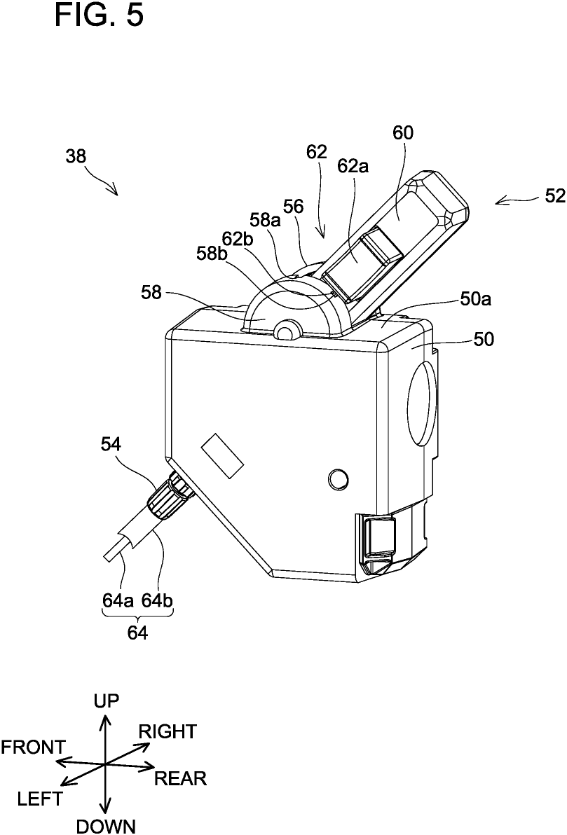

The first operation cable retainer 54 has an operation cable 64 connected thereto. The operation cable 64 includes a first inner cable 64a and a first outer cable 64b surrounding a periphery of the first inner cable 64a. An end of the first inner cable 64a is connected to an end of the operation lever 52 within the operation casing 50 at a position offset from the rotation axis (omitted from drawings). An end of the first outer cable 64b is retained by the first operation cable retainer 54. In a state where the lock button 62a is not pressed in by the user, the engaging part 62b of the lock unit 62 is engaged with the central cutout portion 58a of the operation casing 50. In this state, rotation of the operation lever 52 with respect to the operation casing 50 is restricted. When the lock button 62a is pressed in by the user, the engaging part 62b moves rightward and out of the central cutout portion 58a. In this state, the user can rotate the operation lever 52 with respect to the operation casing 50 in the front-rear direction. Hereinbelow, a position of the operation lever 52 when the engaging part 62b of the operation lever 52 is engaged with the central cutout portion 58a will be described as “first operating position”. As shown in FIG. 5, when the operation lever 52 is operated rearward from the first operating position and the user releases his/her finger(s) from the lock button 62a, the engaging part 62b engages with the rear cutout portion 58b. In this case, the first inner cable 64a of the operation cable 64 moves forward with respect to the first outer cable 64b. Further, as shown in FIG. 4, when the operation lever 52 is operated forward from the first operating position by the user and the user releases his/her finger(s) from the lock button 62a, the engaging part 62b engages with the front cutout portion 58c. In this case, the first inner cable 64a of the operation cable 64 moves rearward with respect to the first outer cable 64b. Hereinbelow, a position of the operation lever 52 as in FIG. 5 and a position of the operation lever 52 as in FIG. 4 are described as “second operating position” and “third operating position”, respectively.

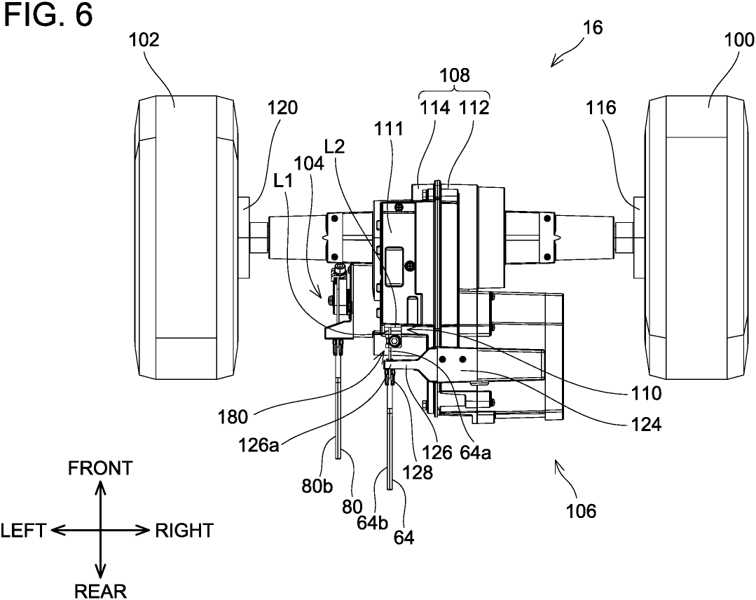

As shown in FIG. 1, the left handle 24 includes a left pipe 70, a left grip 72, a brake casing 74, and a brake lever 76. The left pipe 70 includes a left support (omitted from drawings) extending in the up-down direction and a left handle part 70b bent rearward from an upper end of the left support. The left grip 72 and the brake casing 74 are attached to the left handle part 70b. The left grip 72 is arranged on the rear side of the brake casing 74. The brake lever 76 is attached to a rear portion of the brake casing 74. A brake cable retainer 78 is arranged at a front portion of the brake casing 74. A brake cable 80 is connected to the brake cable retainer 78. The brake cable 80 includes a second inner cable 80a and a second outer cable 80b surrounding a periphery of the second inner cable 80a. An end of the second inner cable 80a is connected to the brake cable 80. An end of the second outer cable 80b is retained by the brake cable retainer 78. When the brake lever 76 is pulled up by the user, brake is applied by a brake unit 104 (see FIG. 6, to be described later) to a right front wheel 100 and a left front wheel 102 (to be described later).

### Configuration of Rear Wheel Unit 18

The rear wheel unit 18 includes a first base plate 90, a right rear wheel 92, and a left rear wheel (omitted from drawings). The right rear wheel 92 and the left rear wheel are driven wheels. The right rear wheel 92 is rotatably supported on a right end of the first base plate 90 and the left rear wheel is rotatably supported on a left end thereof.

### Configuration of Front Wheel Unit 16

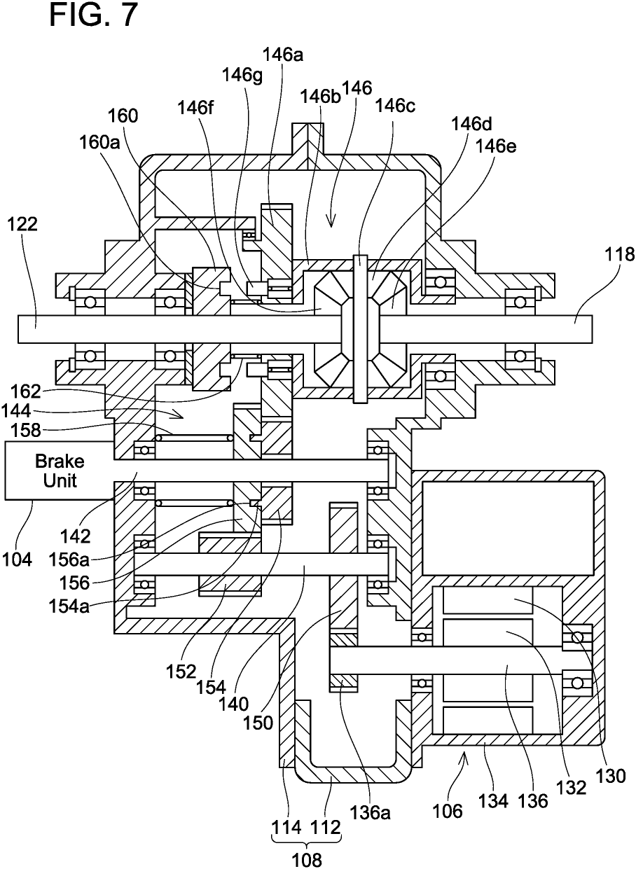

As shown in FIG. 6, the front wheel unit 16 includes the right front wheel 100, the left front wheel 102, the brake unit 104, the motor 106, a gearbox 108, a switching unit 110, and a cover 111. The gearbox 108 includes a right gear casing 112 and a left gear casing 114. A right drive shaft 118 (see FIG. 7) extending in the right gear casing 112 is connected to the right front wheel 100 via a right hub 116. A left drive shaft 122 (see FIG. 7) extending in the left gear casing 114 is connected to the left front wheel 102 via a left hub 120. A first protrusion 124 protruding upward and an extended part 126 extending leftward from a left end of the first protrusion 124 are arranged on an upper surface of a rear portion of the gearbox 108. A second operation cable retainer 128 configured to retain an end of the first outer cable 64b in the operation cable 64 is arranged at a left end 126a of the extended part 126. The brake unit 104 is connected to the left gear casing 114. The brake unit 104 is a so-called disk brake. The cover 111 is screwed onto the left gear casing 114, and covers a part of the switching unit 110 from above.

### Motor 106

As shown in FIG. 7, the motor 106 includes a stator 130, a rotor 132, and a motor casing 134. The motor 106 may for example be a brushless DC motor. The stator 130 and the rotor 132 are housed in the motor casing 134. The stator 130 is fixed to the motor casing 134. The rotor 132 is fixed to a motor shaft 136. The motor shaft 136 extends in the left-right direction and is supported rotatably on the motor casing 134. A first spur gear 136a is fixed to the motor shaft 136. The motor 106 is electrically connected to the battery box 12 (see FIG. 2) via a power cable that is not shown. Electric power is supplied from the battery pack 12a (see FIG. 2) to the motor 106. Operation of the motor 106 is controlled by the controller 12b (see FIG. 2).

### Gearbox 108

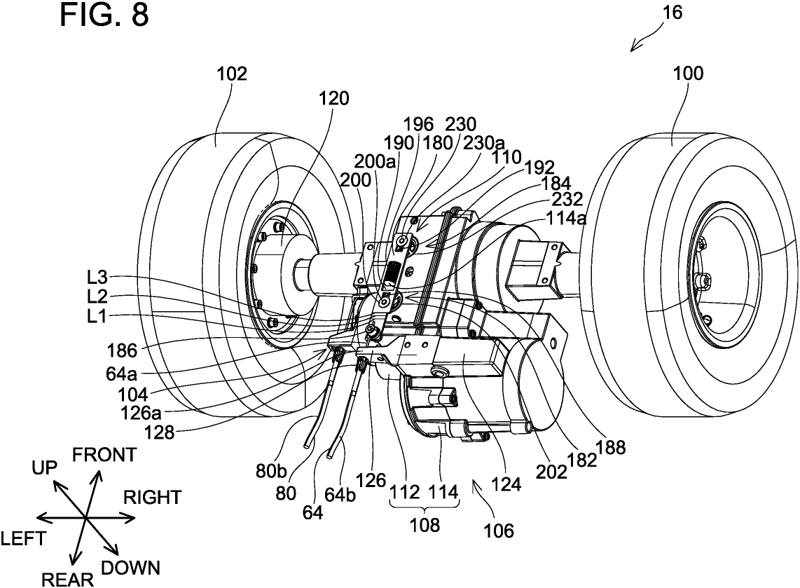

The gearbox 108 includes a first intermediate shaft 140, a second intermediate shaft 142, a clutch mechanism 144, and a differential mechanism 146. The first intermediate shaft 140 extends in the left-right direction and is supported rotatably on the gearbox 108. The first intermediate shaft 140 includes a first gear 150 and a second spur gear 152. The first gear 150 and the second spur gear 152 are fixed to the first intermediate shaft 140. The first gear 150 is meshed with the first spur gear 136a fixed to the motor shaft 136. The second intermediate shaft 142 extends in the left-right direction and is supported rotatably on the gearbox 108. The second intermediate shaft 142 includes a second gear 154. The second gear 154 is configured immobile in the left-right direction but rotatable with respect to the second intermediate shaft 142. The second gear 154 includes a first engaging projection 154a protruding leftward from a left end of the second gear 154. The clutch mechanism 144 includes a first dog clutch 156 retained by the second intermediate shaft 142 so as to be slidable in the left-right direction with respect to the second intermediate shaft 142 and configured to integrally rotate with the second intermediate shaft 142. The first dog clutch 156 includes a first engaging recess 156a dented leftward from a right end of the first dog clutch 156 and with which the first engaging projection 154a of the second gear 154 is to be engaged. A first compression spring 158 is arranged between the first dog clutch 156 and the left gear casing 114. The first compression spring 158 biases the first dog clutch 156 rightward with respect to the left gear casing 114 (that is, in a direction toward the second gear 154). The first dog clutch 156 slides in the left-right direction with respect to the second intermediate shaft 142 by a clutch switching unit 182 to be described later (see FIG. 8). A left end of the second intermediate shaft 142 protrudes outside of the left gear casing 114 and is connected to the brake unit 104. Brake is applied to rotation of the second intermediate shaft 142 by the brake unit 104.

The differential mechanism 146 includes a ring gear 146a, a pinion casing 146b, a pinion shaft 146c, a pinion gear 146d, a right driving gear 146e, and a left driving gear 146f. The ring gear 146a is meshed with the second gear 154 of the second intermediate shaft 142. A second engaging projection 146g protruding leftward from a left end of the ring gear 146a is arranged on the ring gear 146a. The pinion casing 146b is fixed by being screwed onto the ring gear 146a, and is configured to rotate integrally with the ring gear 146a. The ring gear 146a and the pinion casing 146b are retained rotatably on the gearbox 108. The pinion shaft 146c is retained rotatably on the pinion casing 146b. The pinion gear 146d is fixed to the pinion shaft 146c. The right driving gear 146e is fixed to the right drive shaft 118 and is meshed with the pinion gear 146d. The left driving gear 146f is fixed to the left drive shaft 122 and is meshed with the pinion gear 146d.

The differential mechanism 146 further includes a second dog clutch 160. The second dog clutch 160 is retained by the left drive shaft 122 so as to be slidable in the left-right direction with respect to the left drive shaft 122 and configured to rotate integrally with the left drive shaft 122. The second dog clutch 160 includes a second engaging recess 160a that is dented leftward from a right end of the second dog clutch 160 and with which the second engaging projection 146g of the ring gear 146a is to be engaged. A second compression spring 162 is arranged between the second dog clutch 160 and the ring gear 146a. The second compression spring 162 biases the second dog clutch 160 leftward with respect to the left gear casing 114 (that is, in a direction separating away from the ring gear 146a). The second dog clutch 160 moves by sliding in the left-right direction with respect to the left drive shaft 122 by a differential lock switching unit 184 to be described later (see FIG. 8).

### Switching Unit 110

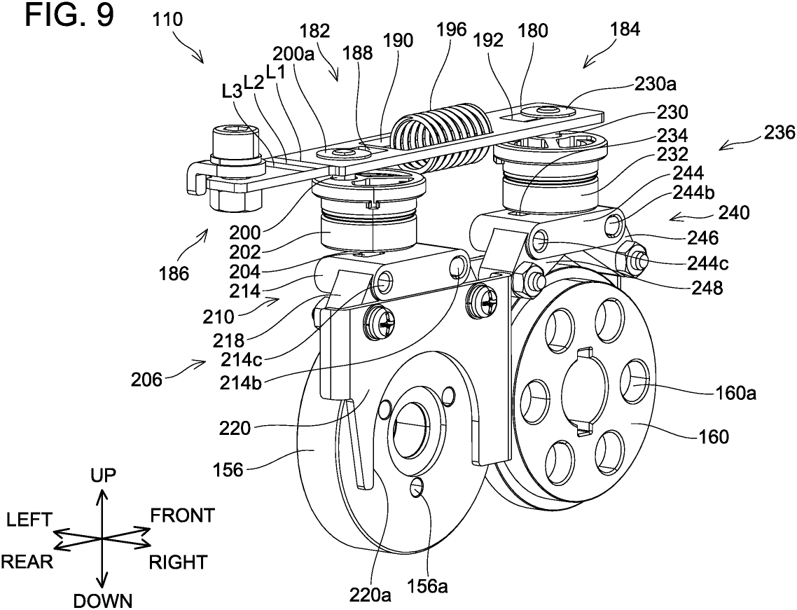

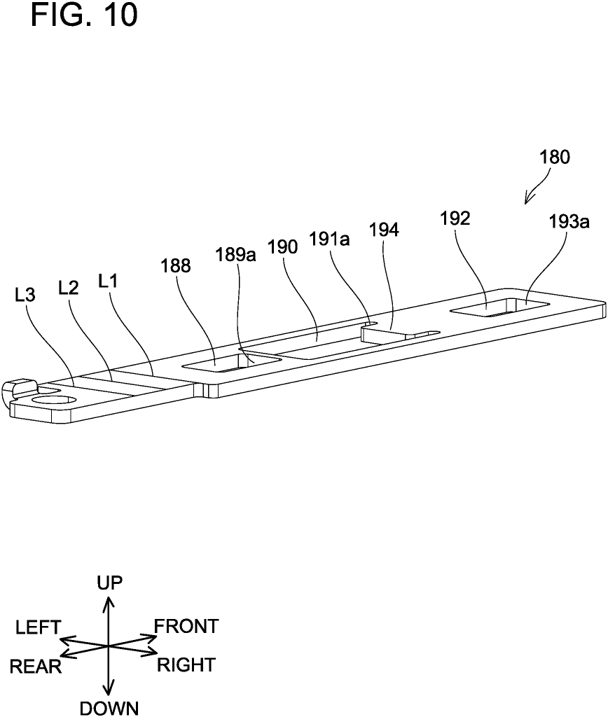

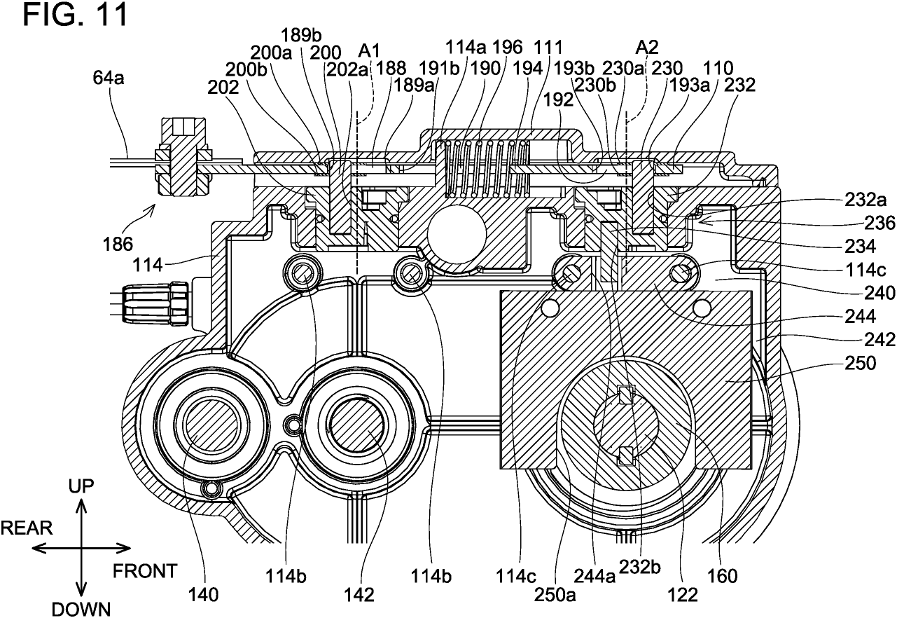

As shown in FIG. 8, the switching unit 110 is attached to the left gear casing 114. As shown in FIG. 9, the switching unit 110 includes a second base plate 180 extending in the front-rear direction, the clutch switching unit 182, and the differential lock switching unit 184. A third operation cable retainer 186 configured to retain an end of the first inner cable 64a of the operation cable 64 (see FIG. 8) is arranged at a rear portion of the second base plate 180. As shown in FIG. 10, the second base plate 180 includes a first opening 188, a second opening 190, and a third opening 192 that are arranged in this order in the front-rear direction. The first opening 188, the second opening 190, and the third opening 192 are each elongated in the front-rear direction. A front end of the first opening 188 is defined by a first front inner surface 189a of the second base plate 180, and a rear end of the first opening 188 is defined by a first rear inner surface 189b of the second base plate 180 (see FIG. 11). A front end of the second opening 190 is defined by a second front inner surface 191a of the second base plate 180, and a rear end of the second opening 190 is defined by a second rear inner surface 191b of the second base plate 180 (see FIG. 11). A front end of the third opening 192 is defined by a third front inner surface 193a of the second base plate 180, and a rear end of the third opening 192 is defined by a third rear inner surface 193b (see FIG. 11). Three position indicator lines, namely a first position indicator line L1, a second position indicator line L2, and a third position indicator line L3, are indicated on an upper surface of the second base plate 180 between the third operation cable retainer 186 and the first opening 188. These first position indicator line L1, second position indicator line L2, and third position indicator line L3 are lines for notifying the user of a position of the switching unit 110 with respect to the left gear casing 114. A spring mount 194 protruding rearward from the second front inner surface 191a is included in the second opening 190. As shown in FIG. 11, a second protrusion 114a protruding upward from the left gear casing 114 is arranged between the second rear inner surface 191b of the second base plate 180 and a rear end of the spring mount 194. A third compression spring 196 is mounted on the spring mount 194. A rear end of the third compression spring 196 contacts the second protrusion 114a, and a front end of the third compression spring 196 contacts the second front inner surface 191a (see FIG. 10). The third compression spring 196 biases the second base plate 180 forward with respect to the left gear casing 114.

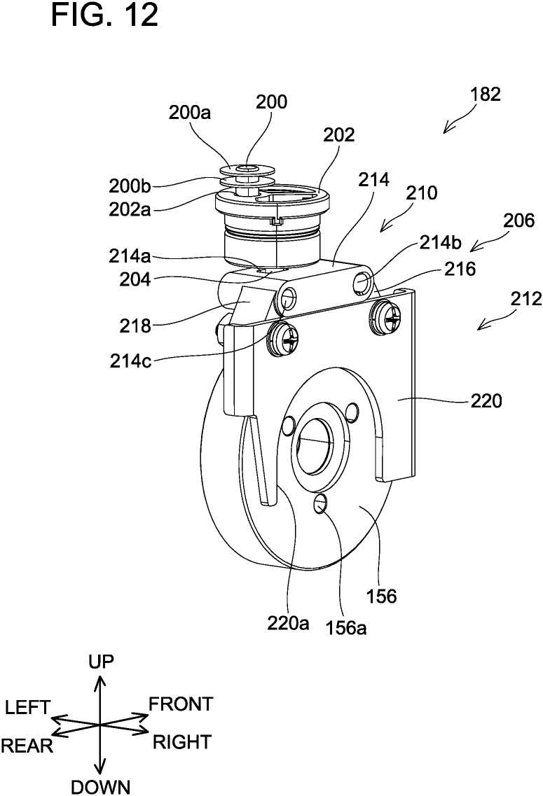

As shown in FIG. 12, the clutch switching unit 182 includes a first pin 200, a first rotating unit 202, a second pin 204, and a first sliding mechanism 206. As shown in FIG. 11, an upper portion of the first pin 200 penetrates through the first opening 188 of the second base plate 180. An outer diameter of the first pin 200 is slightly smaller than a width of the first opening 188 in the left-right direction. Two washers, namely a first washer 200a and a second washer 200b, are attached to the upper portion of the first pin 200. The second base plate 180 is arranged between the first washer 200a and the second washer 200b in the up-down direction. An outer diameter of the first washer 200a and the second washer 200b is larger than the width of the first opening 188 in the left-right direction. The first pin 200 is supported slidably in the front-rear direction with respect to the second base plate 180.

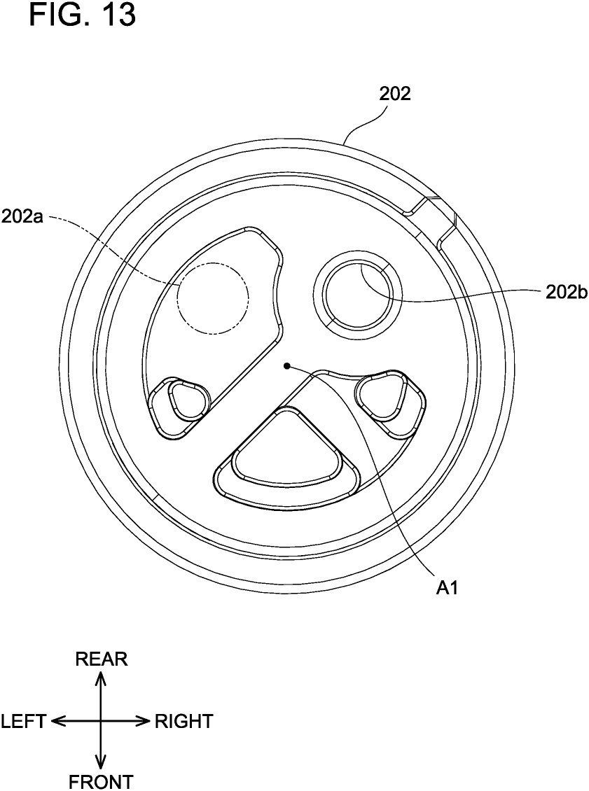

As shown in FIG. 12, a cross-sectional shape of the first rotating unit 202 in the up-down direction is circular. As shown in FIG. 12, a first upper pin hole 202a is defined in an upper surface of the first rotating unit 202. The first upper pin hole 202a is arranged at a position separated from a first rotary axis A1 of the first rotating unit 202 (see FIG. 11). A lower portion of the first pin 200 is insert-molded or press-fitted into the first upper pin hole 202a. The second base plate 180 and the first rotating unit 202 are coupled by first pin 200. As shown in FIG. 13, a first lower pin hole 202b is defined in a lower surface of the first rotating unit 202. The first lower pin hole 202b is arranged at a position separated from the first rotary axis A1 of the first rotating unit 202. The first lower pin hole 202b is arranged at a position that is separated from the first upper pin hole 202a by 90 degrees in a circumferential direction about the first rotary axis A1 of the first rotating unit 202. An upper portion of the second pin 204 (see FIG. 12) is insert-molded or press-fitted into the first lower pin hole 202b. A diameter of the first lower pin hole 202b is same as the outer diameter of the second pin 204.

As shown in FIG. 12, the first sliding mechanism 206 includes a first upper sliding part 210 and a first lower sliding part 212. The first upper sliding part 210 is screwed onto the first lower sliding part 212. The first upper sliding part 210 includes a first base 214 extending in the front-rear direction, a first frontside mount 216 connected to a front end of the first base 214, and a first rearside mount 218 connected to a rear end of the first base 214. A first long hole 214a elongated in the front-rear direction is defined in an upper surface of the first base 214. A lower portion of the second pin 204 is inserted into the first long hole 214a. The first rotating unit 202 and the first sliding mechanism 206 are coupled by the second pin 204. A first through hole 214b extending in the left-right direction is defined at the front end of the first base 214 and a second through hole 214c extending in the left-right direction is defined at the rear end thereof. First support pins 114b (see FIG. 11) extending rightward from an inner wall of the left gear casing 114 at its left end are arranged in the first through hole 214b and the second through hole 214c. The first lower sliding part 212 includes a first push plate 220 extending in the up-down direction. The first frontside mount 216 and the first rearside mount 218 are screwed onto an upper portion of the first push plate 220. A first semicircular opening 220a having a semicircular cross-sectional shape is defined at a lower portion of the first push plate 220. The first dog clutch 156 of the clutch mechanism 144 abuts a left end of the first push plate 220.

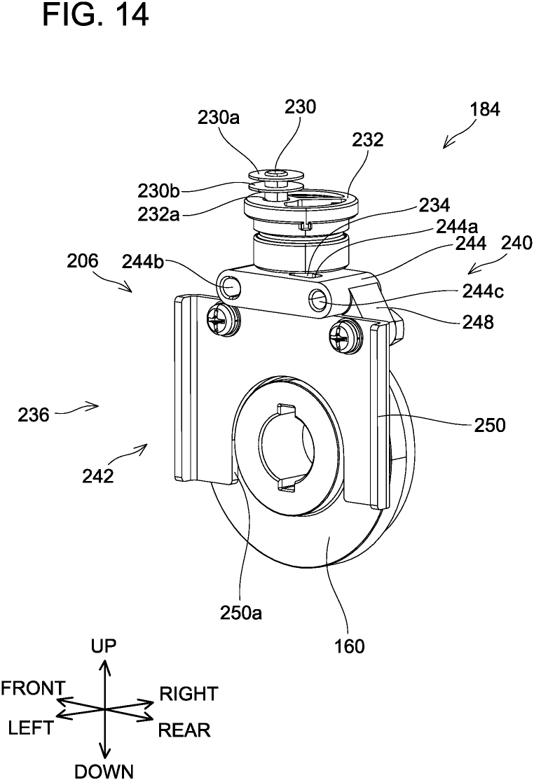

As shown in FIG. 14, the differential lock switching unit 184 includes a third pin 230, a second rotating unit 232, a fourth pin 234, and a second sliding mechanism 236. As shown in FIG. 11, an upper portion of the third pin 230 penetrates through the third opening 192 of the second base plate 180. An outer diameter of the third pin 230 is slightly smaller than a width of the third opening 192 in the left-right direction. Two washers, namely a third washer 230a and a fourth washer 230b, are attached to the upper portion of the third pin 230. The second base plate 180 is arranged between the third washer 230a and the fourth washer 230b in the up-down direction. An outer diameter of the third washer 230a and the fourth washer 230b is larger than the width of the third opening 192 in the left-right direction. The third pin 230 is supported slidably in the front-rear direction with respect to the second base plate 180.

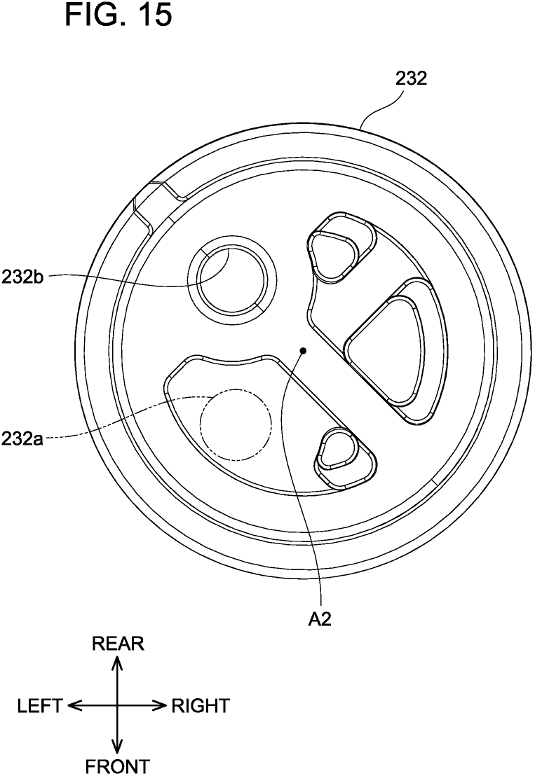

As shown in FIG. 14, a cross-sectional shape of the second rotating unit 232 in the up-down direction is circular. A second upper pin hole 232a is defined in an upper surface of the second rotating unit 232. The second upper pin hole 232a is arranged at a position separated away from a second rotary axis A2 of the second rotating unit 232 (see FIG. 11). A lower portion of the third pin 230 is insert-molded or press-fitted in the second upper pin hole 232a. The second base plate 180 and the second rotating unit 232 are coupled by the third pin 230. A second lower pin hole 232b is defined in a lower surface of the second rotating unit 232. The second lower pin hole 232b is arranged at a position separated away from the second rotary axis A2 of the second rotating unit 232. As shown in FIG. 15, the second lower pin hole 232b is arranged at a position that is separated from the second upper pin hole 232a by 90 degrees in a circumferential direction about the second rotary axis A2 of the second rotating unit 232. As shown in FIG. 11, an upper portion of the fourth pin 234 is insert-molded or press-fitted into the second lower pin hole 232b. A diameter of the second lower pin hole 232b is same as the outer diameter of the fourth pin 234.

As shown in FIG. 14, the second sliding mechanism 236 includes a second upper sliding part 240 and a second lower sliding part 242. The second upper sliding part 240 includes a second base 244 extending in the front-rear direction, a second frontside mount 246 connected to a front end of the second base 244 (see FIG. 9), and a second rearside mount 248 connected to a rear end of the second base 244. A second long hole 244a elongated in the front-rear direction is defined in an upper surface of the second base 244. A lower portion of the fourth pin 234 is inserted into the second long hole 244a. The second rotating unit 232 and the second sliding mechanism 236 are coupled by the fourth pin 234. A third through hole 244b extending in the left-right direction is defined at the front end of the second base 244 and a fourth through hole 244c extending in the left-right direction is defined at the rear end thereof. Second support pins 114c (see FIG. 11) extending rightward from an inner wall of the left gear casing 114 at its left end are arranged in the third through hole 244b and the fourth through hole 244c. The second lower sliding part 242 includes a second push plate 250 extending in the up-down direction. The second frontside mount 246 (see FIG. 9) and the second rearside mount 248 are screwed onto an upper portion of the second push plate 250. A second semicircular opening 250a having a semicircular cross-sectional shape is defined at a lower portion of the second push plate 250. The second dog clutch 160 of the differential mechanism 146 abuts a right end of the second push plate 250.

### First Operation of Operating the Operation Lever 52 From First Operating Position to Second Operating Position or From Second Operating Position to First Operating Position

Next, an operation of the switching unit 110 (see FIG. 9) when the operation lever 52 of FIG. 3 is operated by the user from the first operating position to the second operating position (see FIG. 5) will be described. Hereinbelow, in describing about rotating directions of the first rotating unit 202 of the clutch switching unit 182 and the second rotating unit 232 of the differential lock switching unit 184 as in FIG. 9, their rotating directions seeing the clutch switching unit 182 and the differential lock switching unit 184 from above will be described.

As shown in FIG. 8, in a state where the operation lever 52 (see FIG. 3) is located in the first operating position, the switching unit 110 is located in the first switching position. As shown in FIG. 7, in the state where the switching unit 110 is located in the first switching position, the first engaging projection 154a of the second gear 154 is engaged with the first engaging recess 156a of the first dog clutch 156 of the clutch mechanism 144. In this state, the first dog clutch 156 and the second gear 154 rotate integrally. Due to this, torque from the motor shaft 136 is transmitted to the ring gear 146a of the differential mechanism 146 through the first intermediate shaft 140 and the second intermediate shaft 142. In this case, the differential mechanism 146 rotates both the right drive shaft 118 and the left drive shaft 122 in accordance with the torque transmitted to the ring gear 146a. Hereinbelow, a state of the clutch mechanism 144 in which the first engaging projection 154a of the second gear 154 is engaged with the first engaging recess 156a of the first dog clutch 156 will be termed “transmission state”. Further, in the state where the switching unit 110 is located in the first switching position, the second engaging projection 146g of the ring gear 146a of the differential mechanism 146 is not engaged with the second engaging recess 160a of the second dog clutch 160. In this state, occurrence of a rotation difference between the right drive shaft 118 and the left drive shaft 122 is allowed. Hereinbelow, a state of the differential mechanism 146 in the case where the occurrence of the rotation difference between the right drive shaft 118 and the left drive shaft 122 is allowed will be termed “non-locking state”. As shown in FIG. 6, in the state where the switching unit 110 is located in the first switching position, only the first position indicator line L1 and the second position indicator line L2 are located on the rear side from the cover 111. In this case, the user can only see the first position indicator line L1 and the second position indicator line L2, thus can acknowledge that the state of the clutch mechanism 144 is the transmission state and the state of the differential mechanism 146 is the non-locking state. In the state where the switching unit 110 is located in the first switching position, the user can use the torque transmitted from the motor 106 to move the handcart 2, and thus can easily make right and left turns with the handcart 2.

In this embodiment, biasing forces of the first compression spring 158 (see FIG. 7) contacting the first dog clutch 156 of the clutch mechanism 144, the second compression spring 162 (see FIG. 7) contacting the second dog clutch 160 of the differential mechanism 146, and the third compression spring 196 (see FIG. 9) contacting the second base plate 180 are adjusted so that the switching unit 110 moves to the first switching position when the first inner cable 64a of the operation cable 64 fractures and thus becomes disconnected, for example. According to such a configuration, even when the first inner cable 64a of the operation cable 64 fractures and thus becomes disconnected, the user can still apply brake to the right front wheel 100 and the left front wheel 102 while being on a slope surface, for example.

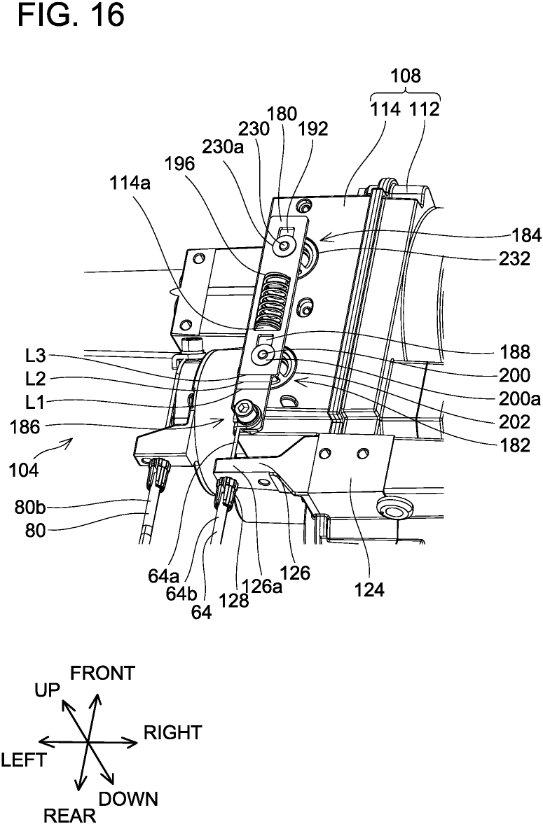

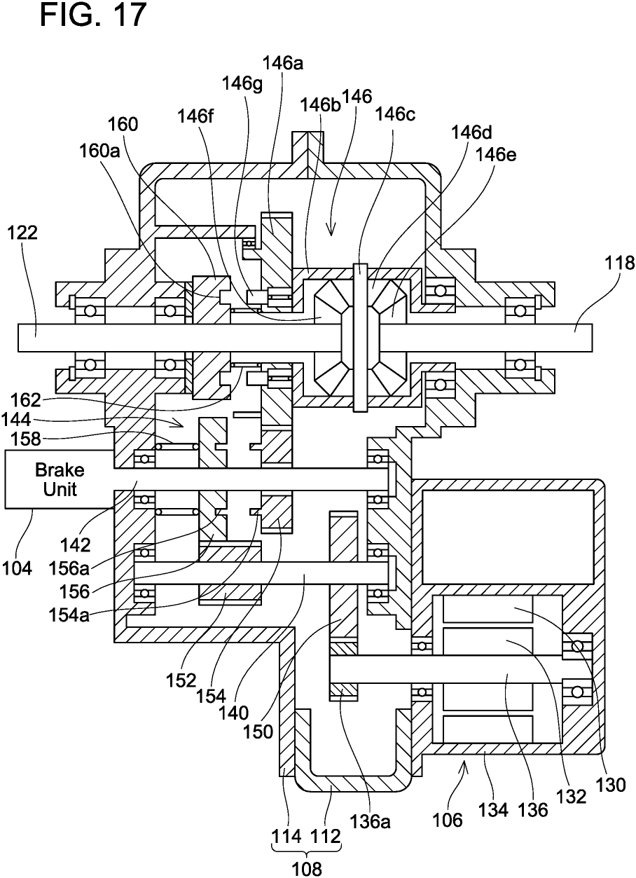

As shown in FIG. 5, when the operation lever 52 is operated by the user from the first operating position to the second operating position, the first inner cable 64a of the operation cable 64 moves forward with respect to the first outer cable 64b. In this case, the first inner cable 64a loosens between the second operation cable retainer 128 (see FIG. 16) and the third operation cable retainer 186 of the switching unit 110 (see FIG. 16). Further, as shown in FIG. 16, the second base plate 180 moves forward with respect to the left gear casing 114 by the biasing force of the third compression spring 196. As shown in FIG. 11, in the state where the switching unit 110 is located in the first switching position, the first pin 200 of the clutch switching unit 182 is not in contact with the first rear inner surface 189b of the first opening 188. The first pin 200 is located slightly forward from the first rear inner surface 189b of the first opening 188. Due to this, the forward movement of the second base plate 180 with respect to the left gear casing 114 brings the first pin 200 into contact with the first rear inner surface 189b of the first opening 188. Due to this, the second base plate 180 and the first pin 200 move forward. When the first pin 200 moves forward, the first rotating unit 202 rotates clockwise. When the first rotating unit 202 of FIG. 9 rotates clockwise, the second pin 204 also rotates clockwise. Further, when the second pin 204 rotates clockwise, the first sliding mechanism 206 coupled to the second pin 204 moves leftward with respect to the left gear casing 114, as a result of which the first dog clutch 156 that is abutting the left end of the first sliding mechanism 206 also moves leftward. In this case, as shown in FIG. 17, the engagement between the first engaging recess 156a of the first dog clutch 156 and the first engaging projection 154a of the second gear 154 is released. In this state, the second gear 154 does not rotate even when the first dog clutch 156 rotates. That is, the torque from the motor shaft 136 is not transmitted to the ring gear 146a of the differential mechanism 146 through the first intermediate shaft 140 and the second intermediate shaft 142. Hereinbelow, a state of the clutch mechanism 144 in which the first engaging recess 156a of the first dog clutch 156 is not engaged with the first engaging projection 154a of the second gear 154 will be termed “non-transmission state”. Further, as shown in FIG. 11 in the state where the switching unit 110 is located in the first switching position, the third pin 230 of the differential lock switching unit 184 is not in contact with the third front inner surface 193a of the third opening 192. The third pin 230 is located slightly rearward from the third front inner surface 193a of the third opening 192. Due to this, the third pin 230 does not move even when the second base plate 180 moves forward with respect to the left gear casing 114. That is, the differential lock switching unit 184 does not move. In this case, as shown in FIG. 17, the second dog clutch 160 of the differential mechanism 146 coupled to the differential lock switching unit 184 also does not move, thus the state in which the second engaging projection 146g of the ring gear 146a is not engaged with the second engaging recess 160a of the second dog clutch 160 (that is, the non-locking state) is maintained. In the state where the switching unit 110 is located in the second switching position as shown in FIG. 16, only the first position indicator line L1 is located on the rear side from the cover 111 (see FIG. 6). In this case, the user can only see the first position indicator line L1, thus can acknowledge that the state of the clutch mechanism 144 is the non-transmission state and the state of the differential mechanism 146 is the non-locking state. In the state in which the switching unit 110 is located in the second switching position, the user can move the handcart 2 by manually pushing the handcart 2, and can further easily make right and left turns with the handcart 2.

As above, when the operation lever 52 of FIG. 1 is operated from the first operating position to the second operating position (see FIG. 5), the state of the clutch mechanism 144 (see FIG. 17) is switched from the transmission state to the non-transmission state without the state of the differential mechanism 146 (see FIG. 17) being switched by the switching unit 110 (see FIG. 9). Further, when the operation lever 52 is operated by the user from the second operating position (see FIG. 5) to the first operating position, the position of the switching unit 110 (see FIG. 9) is switched from the second switching position (see FIG. 16) to the first switching position (see FIG. 9). In this case, as shown in FIG. 7 the state of the clutch mechanism 144 is switched from the transmission state to the non-transmission state without the state of the differential mechanism 146 being switched by the switching unit 110 (see FIG. 9). That is, the switching unit 110 of FIG. 9 switches the state of the clutch mechanism 144 (see FIG. 7) to one of the transmission state and the non-transmission state in response to the user’s first operation on the operation lever 52 (see FIG. 1) without switching the state of the differential mechanism 146 (see FIG. 7).

### Second Operation of Operating the Operation Lever 52 from First Operating Position to Third Operating Position or From Third Operating Position to First Operating Position

### Next, the Operation of the Switching Unit 110 (See FIG. 9) When the Operation Lever 52 of FIG. 3 is Operated by the User From the First Operating Position to the Third Operating Position (See FIG. 4) Will be Descrobed

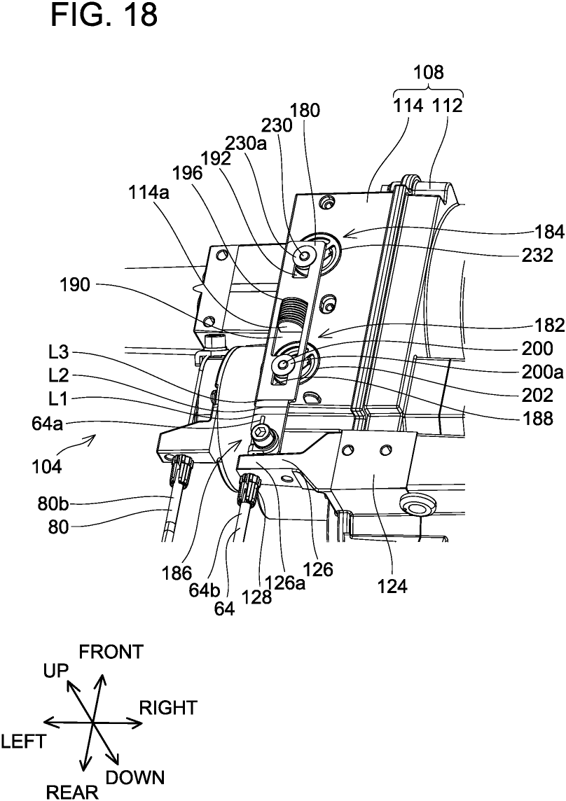

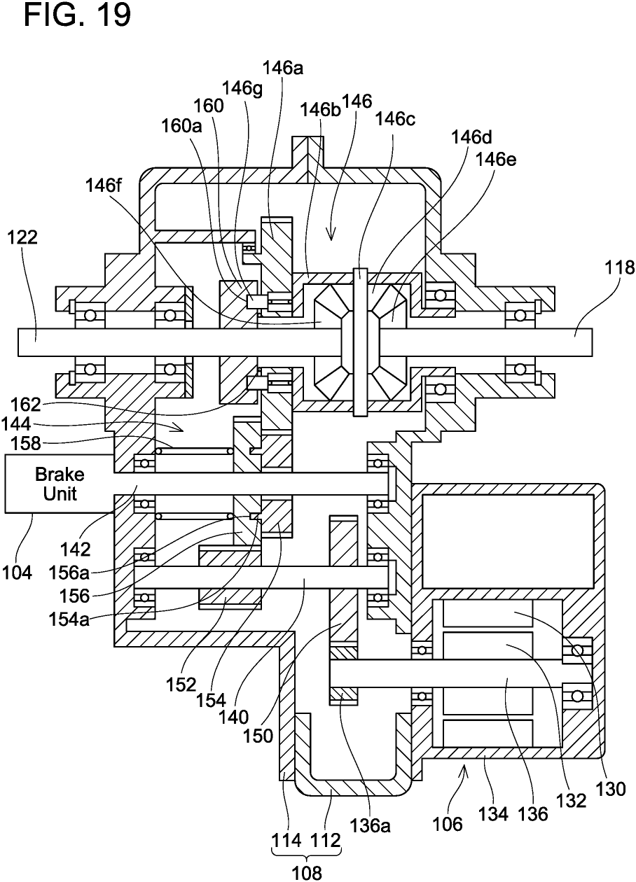

As shown in FIG. 4, when the operation lever 52 is operated by the user from the first operating position to the third operating position, the first inner cable 64a of the operation cable 64 moves rearward with respect to the first outer cable 64b. In this case, as shown in FIG. 18, the second base plate 180 to which the first inner cable 64a of the operation cable 64 is coupled moves rearward with respect to the left gear casing 114. As shown in FIG. 11, in the state where the operation lever 52 is located in the first operating position, the first pin 200 of the clutch switching unit 182 is not in contact with the first rear inner surface 189b of the first opening 188. The first pin 200 is located slightly forward from the first rear inner surface 189b of the first opening 188. Due to this, the first pin 200 does not move even when the second base plate 180 moves rearward with respect to the left gear casing 114. That is, the clutch switching unit 182 does not move. In this case, as shown in FIG. 19, the first dog clutch 156 of the clutch mechanism 144 coupled to the clutch switching unit 182 also does not move, and the state in which the first engaging projection 154a of the second gear 154 is engaged with the first engaging recess 156a of the first dog clutch 156 (that is, the transmission state) is maintained. Further, as shown in FIG. 11, in the state where the operation lever 52 is located in the first operating position, the third pin 230 of the differential lock switching unit 184 is not in contact with the third front inner surface 193a of the third opening 192. The third pin 230 is located slightly rearward from the third front inner surface 193a of the third opening 192. Due to this, the rearward movement of the second base plate 180 with respect to the left gear casing 114 brings the third pin 230 into contact with the third front inner surface 193a of the third opening 192. Due to this, the second base plate 180 and the third pin 230 move rearward. When the third pin 230 moves rearward, the second rotating unit 232 rotates counterclockwise. When the second rotating unit 232 of FIG. 9 rotates counterclockwise, the fourth pin 234 connected to the second rotating unit 232 rotates counterclockwise. Further, when the fourth pin 234 rotates counterclockwise, the second sliding mechanism 236 coupled to the fourth pin 234 moves rightward with respect to the left gear casing 114, and the second dog clutch 160 of the differential mechanism 146 abutting the right end of the second sliding mechanism 236 also moves rightward. In this case, as shown in FIG. 19, the second engaging projection 146g of the differential mechanism 146 engages with the second engaging recess 160a of the second dog clutch 160, whereas in the differential mechanism 146 the ring gear 146a is fixed with respect to the left drive shaft 122, and the right drive shaft 118 and the left drive shaft 122 rotate at the same rotary speed in the same direction. That is, the occurrence of the rotation difference between the right drive shaft 118 and the left drive shaft 122 becomes prohibited. Hereinbelow, the state of the differential mechanism 146 in which the occurrence of the rotation difference between the right drive shaft 118 and the left drive shaft 122 is prohibited will be termed “locking state”. In the state where the switching unit 110 is located in the third switching position as shown in FIG. 18, the first position indicator line L1, the second position indicator line L2, and the third position indicator line L3 are located on the rear side from the cover 111 (see FIG. 6). In this case, the user can see the first position indicator line L1, the second position indicator line L2, and the third position indicator line L3, thus can acknowledge that the state of the clutch mechanism 144 is the transmission state and the state of the differential mechanism 146 is the locking state. In the state where the switching unit 110 is located in the third switching position, the user can use the torque transmitted from the motor 106 to move the handcart 2 straight forward. Further, for example, in a situation where only one of the right front wheel 100 and the left front wheel 102 is in contact with the ground, the torque from the motor 106 can be transmitted to the wheel that is in contact with the ground.

As above, when the operation lever 52 of FIG. 3 is operated from the first operating position to the third operating position (see FIG. 5), the state of the differential mechanism 146 (see FIG. 19) is switched from the non-locking state to the locking state without the state of the clutch mechanism 144 (see FIG. 19) being switched by the switching unit 110 (see FIG. 9). Further, when the operation lever 52 is operated by the user from the third operating position (see FIG. 5) to the first operating position, the position of the switching unit 110 is switched from the third switching position (see FIG. 18) to the first switching position (see FIG. 8). In this case, as shown in FIG. 7 the state of the differential mechanism 146 is switched from the locking state to the non-locking state without the state of the clutch mechanism 144 being switched by the switching unit 110. That is, the switching unit 110 of FIG. 9 switches the state of the differential mechanism 146 (see FIG. 7) to one of the non-locking state and the locking state in response to the user’s second operation on the operation lever 52 (see FIG. 1) without switching the state of the clutch mechanism 144 (see FIG. 7).

In one or more embodiments, as shown in FIGS. 1 to 19, the handcart 2 comprises the motor 106 (an example of “prime mover”), the right front wheel 100 (an example of “first ground-contact part”) and the left front wheel 102 (an example of “second ground-contact part”) that are configured to be driven by the prime mover, the clutch mechanism 144 configured to switch between the transmission state and the non-transmission state, wherein the transmission state is a state in which torque from the motor 106 is transmitted to the right front wheel 100 and to the left front wheel 102 and the non-transmission state is a state in which the torque from the motor 106 is not transmitted to the right front wheel 100 nor to the left front wheel 102, the differential mechanism 146 configured to distribute the torque from the motor 106 to the right front wheel 100 and the left front wheel 102 and configured to switch between the non-locking state and the locking state, wherein the non-locking state is a state allowing the rotation difference to occur between the right front wheel 100 and the left front wheel 102 and the locking state is a state prohibiting the rotation difference from occurring between the right front wheel 100 and the left front wheel 102, the second base plate 180 (an example of “switching unit”) configured to switch the state of the clutch mechanism 144 and the state of the differential mechanism 146, and the operation lever 52 (an example of “operation unit”). The second base plate 180 is configured to: in response to the user’s first operation on the operation lever 52, switch the state of the clutch mechanism 144 between the transmission state and the non-transmission state without switching the state of the differential mechanism 146, and in response to the user’s second operation on the operation lever 52, switch the state of the differential mechanism 146 between the non-locking state and the locking state without switching the state of the clutch mechanism 144. According to the above configuration, the second base plate 180 can realize three states, namely the state in which the differential mechanism 146 is in the non-locking state and the clutch mechanism 144 is in the transmission state, the state in which the differential mechanism 146 is in the non-locking state and the clutch mechanism 144 is in the non-transmission state, and the state in which the differential mechanism 146 is in the locking state and the clutch mechanism 144 is in the transmission state. Thus, user convenience can be improved.

Further, in one or more embodiments, as shown in FIGS. 1 to 19, the handcart 2 comprises the motor 106, the right front wheel 100 and the left front wheel 102 that are configured to be driven by the motor 106, the clutch mechanism 144 configured to switch between the transmission state and the non-transmission state, wherein the transmission state is a state in which torque from the motor 106 is transmitted to the right front wheel 100 and to the left front wheel 102 and the non-transmission state is a state in which the torque from the motor 106 is not transmitted to the right front wheel 100 nor to the left front wheel 102, the differential mechanism 146 configured to distribute the torque from the motor 106 to the right front wheel 100 and the left front wheel 102 and configured to switch between the non-locking state and the locking state, wherein the non-locking state is a state allowing the rotation difference to occur between the right front wheel 100 and the left front wheel 102 and the locking state is a state prohibiting the rotation difference from occurring between the right front wheel 100 and the left front wheel 102, the second base plate 180 configured to switch the state of the clutch mechanism 144 and the state of the differential mechanism 146, and the operation lever 52. The second base plate 180 is configured to move between the first switching position (an example of “first position”), the second switching position (an example of “second position”), and the third switching position (an example of “third position”) in response to the user’s operation on the operation lever 52, wherein when the second base plate 180 is at the first switching position, the differential mechanism 146 is in the non-locking state and the clutch mechanism 144 is in the transmission state, when the second base plate 180 is at the second switching position, the differential mechanism 146 is in the non-locking state and the clutch mechanism 144 is in the non-transmission state, and when the second base plate 180 is at the third switching position, the differential mechanism 146 is in the locking state and the clutch mechanism 144 is in the transmission state. According to the above configuration, the three states, namely the state in which the differential mechanism 146 is in the non-locking state and the clutch mechanism 144 is in the transmission state, the state in which the differential mechanism 146 is in the non-locking state and the clutch mechanism 144 is in the non-transmission state, and the state in which the differential mechanism 146 is in the locking state and the clutch mechanism 144 is in the transmission state, can be realized by the second base plate 180. Thus, user convenience can be improved.

Further, in one or more embodiments, as shown in FIGS. 7, 8, and 16 to 19, the state of the clutch mechanism 144 and/or the state of the differential mechanism 146 are switched by the movement of the second base plate 180 in the front-rear direction (an example of “first direction”). According to the above configuration, the configuration of the handcart 2 can be simplified as compared to a case in which the state of the clutch mechanism 144 and/or the state of the differential mechanism 146 are switched by the second base plate 180 rotating in response to the user’s operation on the operation lever 52.

For example, when the state of the clutch mechanism 144 is switched from the transmission state to the non-transmission state, the handcart 2 could inadvertently move on a slope surface even through the motor 106 is stopped. In one or more embodiments, as shown in FIG. 1, the handcart 2 further comprises the handle unit 10 (an example of “handle”) configured to be gripped by the user. The operation lever 52 is disposed on the handle unit 10. According to the above configuration, the user can grip the handle unit 10 with one hand and operate the operation lever 52 with the other hand. As such, the handcart 2 can be suppressed from inadvertently moving on the slope, and the state in which the handcart 2 is stopped still can be maintained.

Further, in one or more embodiments, as shown in FIG. 8, the second base plate 180 comprises the first position indicator line L1, the second position indicator line L2, and the third position indicator line L3 (examples of “position indicator”) each configured to indicate a position of the second base plate 180 relative to the clutch mechanism 144 and the differential mechanism 146. According to the above configuration, the user can acknowledge the state of the clutch mechanism 144 and the state of the differential mechanism 146 by checking the position of the second base plate 180 indicated by the first position indicator line L1, the second position indicator line L2, and the third position indicator line L3. Thus, the user convenience can further be improved.

(First Variant) The handcart 2 may be configured to realize a state in which the state of the clutch mechanism 144 is the non-transmission state and the state of the differential mechanism 146 is the locking state by the second base plate 180.

(Second Variant) The “first ground-contact part” and the “second ground-contact part” may not be limited to wheels, but may be rollers or crawlers.

(Third Variant) The “prime mover” is not limited to the motor 106 but may be an engine.

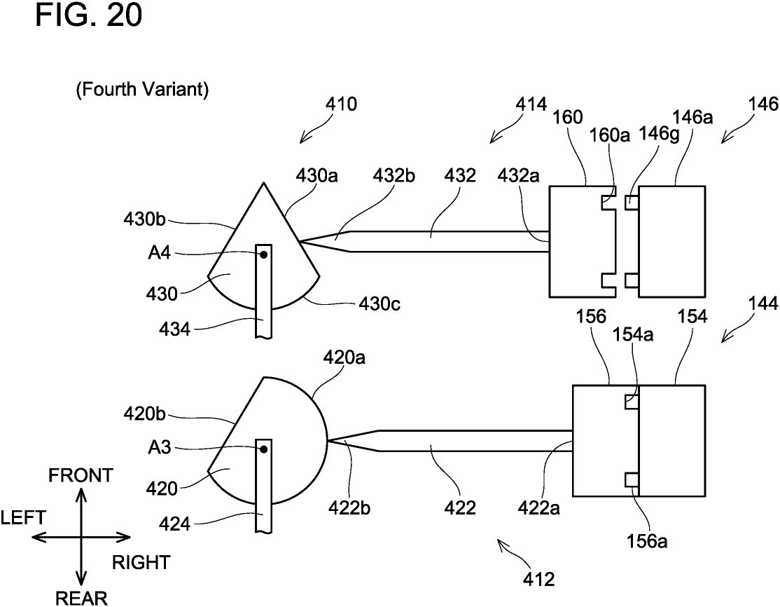

(Fourth Variant) The state of the clutch mechanism 144 and/or the state of the differential mechanism 146 may be switched by rotary motion of the “switching unit”. For example, as shown in FIG. 20, a switching unit 410 may comprise a clutch switching unit 412 and a differential lock switching unit 414. The clutch switching unit 412 is arranged on upper front side of the differential lock switching unit 414. The clutch switching unit 412 includes a clutch switching cam 420, a clutch switching pin 422, and a first link mechanism 424. A right end 422a of the clutch switching pin 422 is fixed to the first dog clutch 156 and a left end 422b thereof is in contact with an outer circumferential surface of the clutch switching cam 420. The first link mechanism 424 is configured to rotate the clutch switching cam 420 about a third rotary axis A3 in response to the user’s operation on the operation lever 52 (see FIG. 1). In this variant, a compression spring (omitted from drawing) configured to bias the first dog clutch 156 leftward with respect to the second gear 154 is arranged between the second gear 154 and the first dog clutch 156. In a state where the left end 422b of the clutch switching pin 422 is in contact with a first arcuate surface 420a of the clutch switching cam 420, the first engaging projection 154a of the second gear 154 is engaged with the first engaging recess 156a of the first dog clutch 156. That is, the state of the clutch mechanism 144 is the transmission state. The differential lock switching unit 414 includes a differential lock switching cam 430, a differential lock switching pin 432, and a second link mechanism 434. A right end 432a of the differential lock switching pin 432 is fixed to the second dog clutch 160 and a left end 432b thereof is in contact with an outer circumferential surface of the differential lock switching cam 430. The second link mechanism 434 is configured to rotate the differential lock switching cam 430 about a fourth rotary axis A4 in response to the user’s operation on the operation lever 52 (see FIG. 1). In this variant, a compression spring (omitted from drawing) configured to bias the second dog clutch 160 leftward with respect to the ring gear 146a is arranged between the ring gear 146a and the second dog clutch 160. In a state where the left end 432b of the differential lock switching pin 432 is in contact with a first flat surface 430a of the differential lock switching cam 430, the second engaging projection 146g of the ring gear 146a is not engaged with the second engaging recess 160a of the second dog clutch 160. That is, the state of the differential mechanism 146 is the non-locking state.

In this variant, when the operation lever 52 is operated from the first operating position (see FIG. 3) to the second operating position (see FIG. 5), the clutch switching cam 420 and the differential lock switching cam 430 rotate clockwise. In this case, the left end 422b of the clutch switching pin 422 comes into contact with a flat surface 420b of the clutch switching cam 420, and the first dog clutch 156 thereby moves leftward with respect to the second gear 154. Due to this, the engagement between the first engaging recess 156a of the first dog clutch 156 and the first engaging projection 154a of the second gear 154 is released. That is, the state of the clutch mechanism 144 is switched from the transmission state to the non-transmission state. Further, the left end 432b of the differential lock switching pin 432 comes into contact with the second flat surface 430b of the differential lock switching cam 430. In this case, the state in which the second engaging projection 146g of the ring gear 146a is not engaged with the second engaging recess 160a of the second dog clutch 160 (that is, the non-locking state) is maintained.

Further, in this variant, the clutch switching cam 420 and the differential lock switching cam 430 rotate counterclockwise when the operation lever 52 is operated from the first operating position (see FIG. 3) to the third operating position (see FIG. 4). In this case, the state in which the left end 422b of the clutch switching pin 422 is in contact with the first arcuate surface 420a of the clutch switching cam 420 (that is, the transmission state) is maintained. On the other hand, the left end 432b of the differential lock switching pin 432 comes into contact with a second arcuate surface 430c of the differential lock switching cam 430, and the second dog clutch 160 thereby moves rightward with respect to the ring gear 146a. Due to this, the second engaging projection 146g of the ring gear 146a engages with the second engaging recess 160a of the second dog clutch 160. That is, the state of the differential mechanism 146 is switched from the non-locking state to the locking state. With such a configuration as well, the same effects as those of the embodiment can be achieved. In this variant, the clutch switching cam 420 and the differential lock switching cam 430 are examples of the “switching unit”.

(Fifth Variant) The “operation unit” may be disposed at a position other than the handle unit 10, such as on the chassis frame 14. Further, in another variant, the “operation unit” and the “switching unit” may not have link mechanism and the like and may be integrated.

(Sixth Variant) The handcart 2 may comprise a loop handle instead of the handle unit 10. For example, the loop handle may include a right support extending upward from the right end of the chassis frame 14 of FIG. 1, a right extended part extending rearward from an upper end of the right support, a left support extending upward from the left end of the chassis frame 14 (see FIG. 1), a left extended part extending rearward from an upper end of the left support, and a grip part that connects a rear end of the right extended part with a rear end of the left extended part. In this variant, the “operation unit” is preferably disposed on the right extended part.

(Seventh Variant) The second base plate 180 may not include the first position indicator line L1, the second position indicator line L2, and the third position indicator line L3. That is, the “position indicator” may be omitted.

(Eighth Variant) For example, the biasing forces of the first compression spring 158, the second compression spring 162, and the third compression spring 196 may be adjusted so that the switching unit 110 moves to the second switching position when the first inner cable 64a of the operation cable 64 fractures and becomes disconnected. In this case, when the first inner cable 64a of the operation cable 64 fractures and becomes disconnected, the user can manually move the handcart 2. Further, in another variant, the biasing forces of the first compression spring 158, the second compression spring 162, and the third compression spring 196 may be adjusted so that the switching unit 110 moves to the third switching position when the first inner cable 64a of the operation cable 64 fractures and becomes disconnected. In this case, even when the first inner cable 64a of the operation cable 64 fractures and becomes disconnected, the handcart 2 can be moved straight forward using the torque transmitted from the motor 106.

What is claimed is:

1. A handcart comprising:
a prime mover;
a first ground-contact part and a second ground-contact part that are configured to be driven by the prime mover;
a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part;
a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state is a state prohibiting the rotation difference from occurring between the first ground-contact part and the second ground-contact part;
a switching unit configured to switch a state of the clutch mechanism and a state of the differential mechanism; and
an operation unit,
wherein the switching unit is configured to:
in response to a user’s first operation on the operation unit, switch the state of the clutch mechanism between the transmission state and the non-transmission state without switching the state of the differential mechanism, and
in response to a user’s second operation on the operation unit, switch the state of the differential mechanism between the non-locking state and the locking state without switching the state of the clutch mechanism.

2. The handcart according to claim 1, wherein the state of the clutch mechanism and/or the state of the differential mechanism are/is switched by movement of the switching unit along a first direction.

3. The handcart according to claim 1, further comprising a handle configured to be gripped by a user,
wherein the operation unit is disposed on the handle.

4. The handcart according to claim 1, wherein the switching unit comprises a position indicator configured to indicate a position of the switching unit relative to the clutch mechanism and the differential mechanism.

5. A handcart comprising:
a prime mover;
a first ground-contact part and a second ground-contact part that are configured to be driven by the prime mover;
a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part;
a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state is a state prohibiting the rotation difference from occurring between the first ground-contact part and the second ground-contact part;
a switching unit configured to switch a state of the clutch mechanism and a state of the differential mechanism; and
an operation unit,
wherein, the switching unit is configured to move between a first position, a second position, and a third position in response to a user’s operation on the operation unit,
wherein when the switching unit is at the first position, the differential mechanism is in the non-locking state and the clutch mechanism is in the transmission state,
when the switching unit is at the second position, the differential mechanism is in the non-locking state and the clutch mechanism is in the non-transmission state, and
when the switching unit is at the third position, the differential mechanism is in the locking state and the clutch mechanism is in the transmission state.

6. The handcart according to claim 5, wherein the state of the clutch mechanism and/or the state of the differential mechanism are/is switched by movement of the switching unit along a first direction.

7. The handcart according to claim 5, further comprising a handle configured to be gripped by a user,
wherein the operation unit is disposed on the handle.

8. The handcart according to claim 5, wherein the switching unit comprises a position indicator configured to indicate a position of the switching unit relative to the clutch mechanism and the differential mechanism.

9. A handcart comprising:
a prime mover;
a first ground-contact part and a second ground-contact part that are configured to be driven by the prime mover;
a clutch mechanism configured to switch between a transmission state and a non-transmission state, wherein the transmission state is a state in which torque from the prime mover is transmitted to the first ground-contact part and to the second ground-contact part and the non-transmission state is a state in which the torque from the prime mover is not transmitted to the first ground-contact part nor to the second ground-contact part;
a differential mechanism configured to distribute the torque from the prime mover to the first ground-contact part and the second ground-contact part and configured to switch between a non-locking state and a locking state, wherein the non-locking state is a state allowing a rotation difference to occur between the first ground-contact part and the second ground-contact part and the locking state being a state prohibiting the rotation difference from occurring between the first ground-contact part and the second ground-contact part;
a switching unit configured to switch a state of the clutch mechanism and a state of the differential mechanism; and
an operation unit,
wherein the switching unit is configured to:
in response to a user’s first operation on the operation unit, switch the state of the clutch mechanism between the transmission state and the non-transmission state without switching the state of the differential mechanism, and
in response to a user’s second operation on the operation unit, switch the state of the differential mechanism between the non-locking state and the locking state without switching the state of the clutch mechanism,
wherein the state of the clutch mechanism and/or the state of the differential mechanism are/is switched by movement of the switching unit along a first direction,
wherein the handcart further comprises a handle configured to be gripped by a user,
wherein the operation unit is disposed on the handle, and
wherein the switching unit comprises a position indicator configured to indicate a position of the switching unit relative to the clutch mechanism and the differential mechanism.
